(19) United States
(12) Patent Application Publication
(10) Pub. No.: US 2005/0209880 A1
(43) Pub. Date: Sep. 22, 2005

(54) Integrated healthcare information system

(76) Inventors: Peggy A. Drelicharz, Cedar Creek, NE (US); Dennis L. Kastens, Omaha, NE (US); Christopher C. Oster, Omaha, NE (US); Subramaniam Vaikuntam, Chennai (IN); Radhakrishna Sarma Prakhya, Chennai (IN); Kalyanaraman Rajaram, Chennai (IN); Kamal V. Kumar, Chennai (IN); Krishna M. Kumar, Chennai (IN); Baiju P. Sankaran, Chennai (IN); R. Lakshmy Narayanan, Chennai (IN)

Correspondence Address: SUITER WEST SWANTZ PC LLO, 14301 FNB PARKWAY, SUITE 220, OMAHA, NE, 68154, US

(21) Appl. No.: 10/832,814

(22) Filed: Apr. 26, 2004

Related U.S. Application Data
(60) Provisional application No. 60/465,848, filed on Apr. 24, 2003.

(51) Int. Cl. G06F 17/60

(52) U.S. Cl. 705/2

(57) ABSTRACT

An integrated healthcare network provides a clinical documentation functionality fully integrated with a financial tracking functionality. The integrated healthcare network provides a fully flexible and customizable clinical documentation capability. This allows healthcare providers to accommodate various needs which arise during the course of diagnosing and treating individual patients. The financial tracking functionality provides for the accounting and management of expenses incurred and revenues generated during the course of the healthcare provided. The integrated healthcare network establishes a relational system which provides information across the entire system.

### CROSS REFERENCE TO RELATED APPLICATION

The present application claims priority under 35 U.S.C. §119 to the U.S. Provisional Application Ser. No. 60/465,848, filed on Apr. 24, 2003, which is herein incorporated by reference in its entirety.

### FIELD OF THE INVENTION

The present invention generally relates to the field of systems, methods, and computer products for managing patient healthcare, and more particularly to a healthcare computing network system and processes by which all aspects of patient healthcare is integrated into a single point of access and delivery system.

### BACKGROUND OF THE INVENTION

The delivery of medical care in a timely and efficient manner is a critical component of today's medical institutions. Faced with the ever increasing competitive landscape of the healthcare industry, medical care providers are challenged to provide better care while reducing costs.

The timeliness of the delivery of healthcare is affected by many factors and may include the time spent for diagnosing a problem, to time spent devising a treatment plan, to time spent ordering and administering necessary medications, to time spent documenting each activity occurring within the treatment plan. The time associated with each of these identified intervals may impair a healthcare provider's ability to effectively and efficiently provide timely delivery of care to those patients in need. In addition, the time spent performing many of the necessary tasks within each of the identified intervals may result in decreased productivity of the health care provider, which may result in loss of income generation.

Another reality faced by modern healthcare providers is an increase in the complexity of treatment options being presented to them. The complexity of modern treatment and service options available increases the need for an efficient system in order to make accessible and deliver these healthcare options. Further, the modern healthcare provider is challenged to maintain complete and accurate records of all treatment and service options provided to an individual patient in an “up-to-the-minute” manner. The institutions providing the healthcare facilities are faced with the challenge of maintaining complete and accurate records for all patients, which are provided treatment. Additionally, the individual healthcare provider and the healthcare institutions may require access to past medical records in order to effectively treat a repeat individual patient.

It is also critical to the effective treatment of patients that the records maintained are effectively identified with the proper patient. This is particularly necessary in many healthcare environments, such as where an individual patient is being cared for by multiple healthcare providers or where multiple patients are being cared for by an individual healthcare provider.

It may commonly be the case that where individual patients seek multiple opinions on the best course of treatment from various healthcare providers, that the patient must manually transfer previous information, such as medical records. This may lead to misplaced or lost information which may result in ineffective or inaccurate courses of treatment being diagnosed and/or followed.

Currently, many of the systems used by healthcare institutions and individual healthcare providers may rely on manual dictation, transcription, and transportation practices related to medical records. These types of systems may result in increased time spent by the healthcare institutions and providers in the gathering, completion, and maintenance of medical records associated with patients. The inefficiencies inherent in these systems may result in lost revenues and may also result in a fewer number of patients being afforded access to healthcare. Further, medical errors, such as the wrong medication and/or dosages of medication being given to the wrong patient, the wrong surgeries being performed upon the wrong patients, and even failures to deliver and administer needed medication are unfortunate problems which have been associated with these types of systems. In these systems where handwritten notes on various pieces of paper are often the primary instrument for the communication of critical information it may be common that instructions are misinterpreted or even not fully understandable, thereby, resulting in lost time spent clarifying instructions and increased frustration in the workplace.

The management of the numerous financial transactions which may take place during the process of providing healthcare to an individual has commonly suffered from many inefficiencies, which may have resulted in a failure to fully capture billing opportunities and therefore resulted in lost revenue. Additionally, many of the commonly used systems for tracking financial costs associated with treatment have experienced failures to accurately report all costs incurred resulting in negative income generation. This may in turn lead to higher healthcare costs per patient in order to make up for the failures of the system.

Therefore, it would be desirable to provide an integrated healthcare network which provides flexible clinical documentation functionality integrated with a financial tracking functionality.

### SUMMARY OF THE INVENTION

Accordingly, the present invention provides an integrated healthcare network enabling a clinical documentation functionality fully integrated with a financial tracking functionality. The integrated healthcare network comprises a complete electronic medical record system by providing a fully flexible and customizable clinical documentation capability. This allows healthcare providers to accommodate various needs which arise during the course of diagnosing and treating individual patients. The financial tracking functionality provides for the accounting and management of expenses incurred and revenues generated during the course of the healthcare provided. The integrated healthcare network establishes a relational system which provides information across the entire system. Thus, information associated in one stage of the healthcare process is provided throughout all stages of the process eliminating the need for repetitive entries. The increased efficiency provided by the present invention may result in increased cost savings, due to reduced time spent in establishing, completing, and maintaining records, as well as increased revenue generation provided through the maximizing of the capture of billing opportunities and increased accuracy in the reporting of all costs associated with treatment.

In a first aspect of the present invention, a clinical patient chart for use with a computing system is provided. The clinical patient chart includes a clinical documentation graphical user interface communicatively coupled with a database. A chart form including an interactive display form is communicatively coupled with the clinical documentation graphical user interface and the database. Further, a clinical documentation option is communicatively coupled with the chart form, the clinical documentation option providing a plurality of interactive display forms for charting and tracking patient information. The clinical documentation option provides an integrated clinical information set of a patient for display on, and manipulation by a user, of the computing system employing the clinical patient chart of the present invention.

In a second aspect of the present invention, a financial tracker is provided. The financial tracker includes a general ledger allowing journal entries for creating a financial statement. The general ledger is communicatively coupled with a chart of accounts, the chart of accounts for tracking of revenues and expenses from a core account and a minor account. The chart of accounts matches the core account with the minor account to provide the revenues and expenses for the financial tracker.

In a third aspect of the present invention, an integrated healthcare network is provided. The integrated healthcare network includes a clinical patient chart communicatively coupled to a database, the clinical patient chart for entry, manipulation, and display of data. Communicatively coupled to the clinical patient chart and the database is a financial tracker, the financial tracker for entry, manipulation, and display of data. The clinical patient chart and financial tracker provide clinical documentation, order management, and revenue management within the integrated healthcare network.

In a fourth aspect of the present invention, a clinical documentation electronic chart form is provided. The clinical documentation electronic chart form is communicatively coupled with a server which is communicatively coupled with a database. The clinical documentation electronic chart form may be used by a healthcare provider in providing medical care to a patient and comprises a summary option for providing history information, medication information, allergy information, surgical information, and diagnosis information. Communicatively coupled with the summary option is a 24 hour summary option for providing vital signs, intake/output, orders, lab results, and medication information covering a previous twenty four hour period of time. An order option communicatively coupled with the summary option provides for the entry of orders related to medical care. A care plan option is communicatively coupled with the summary option, the care plan option provides a multi-disciplinary care plan activity function. A flowsheet option is communicatively coupled with the summary option and provides a form for data entry. A wizard option is communicatively coupled with the summary option, 24 hour summary option, order option, care plan option, and flowsheet option, the wizard option provides for customization of information provided by the clinical documentation electronic chart form.

In a fifth aspect of the present invention, a financial tracker is provided. The financial tracker is communicatively coupled with a server communicatively coupled with a database. The financial tracker may be for use by a healthcare provider in providing medical care to a patient and comprise a patient registration for establishing a record number for the patient being treated by the healthcare provider. Communicatively coupled with the patient registration is a medical records option for storing and accessing a medical image. A general ledger is communicatively coupled with the patient registration, the general ledger is for journal entries and includes a core account option and a minor account option for entering revenues and expenses. A billing option is communicatively coupled with the general ledger, the billing option creates billing statements including accounts payable and accounts receivable. An insurance option is further communicatively coupled with the general ledger and provides insurance processing.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a system block diagram in accordance with an exemplary embodiment of the present invention, wherein an integrated healthcare information system shows details of the hardware element and local area/internet network;

FIG. 2a is an illustration of a block diagram of a computer system in accordance with an exemplary embodiment of the present invention;

FIG. 2b is a graphic user interface screen of the clinical documentation system in accordance with an exemplary embodiment of the present invention;

FIG. 3 is a schematic diagram illustrating relationships of various options in the clinical documentation system in accordance with an exemplary embodiment of the present invention;

FIG. 4 is a graphic user interface screen of a “patient summary” option in accordance with an exemplary embodiment of the present invention;

FIG. 5 is a schematic diagram illustrating a “24 hour summary” option in the clinical documentation system in accordance with an exemplary embodiment of the present invention;

FIG. 6 is a graphic user interface screen of the “24 hour summary” option in accordance with an exemplary embodiment of the present invention;

FIG. 7 is a schematic diagram illustrating a “care management” option in the clinical documentation system in accordance with an exemplary embodiment of the present invention;

FIG. 8 is a graphic user interface screen of the “care management” option in accordance with an exemplary embodiment of the present invention;

FIG. 9 is a schematic diagram illustrating an “orders” option in the clinical documentation system in accordance with an exemplary embodiment of the present invention;

FIG. 10 is a user interface screen of the “orders” option in accordance with an exemplary embodiment of the present invention;

FIG. 11 is a schematic diagram illustrating a “flowsheets” option in the clinical documentation system in accordance with an exemplary embodiment of the present invention;

FIG. 12a is a graphic user interface screen of a flowsheet form in accordance with an exemplary embodiment of the present invention;

FIG. 12b is another graphic user interface screen of a flowsheet form in accordance with an exemplary embodiment of the present invention;

FIG. 13 is a schematic diagram illustrating a “physician's view” option in the clinical documentation system in accordance with an exemplary embodiment of the present invention; and

FIG. 14 is a graphic user interface screen of a “physician's view” option in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

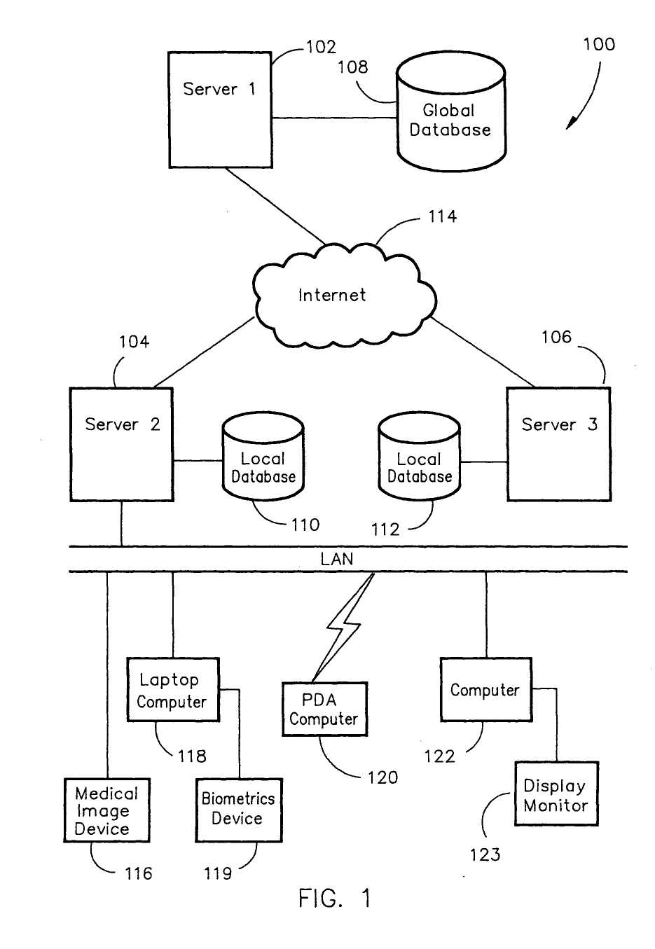

Referring generally now to FIGS. 1 through 14, exemplary embodiments of the present invention are shown.

Referring more particularly to FIG. 1, there is shown generally an integrated healthcare information system 100 in accordance with one embodiment of the present invention. The integrated healthcare information system 100 shown in FIG. 1 comprises a master server 102 communicatively coupled with a global database 108 and a plurality of medical facility servers 104-106 communicatively coupled with medical facility databases(local databases) 110-112. The servers (master server and each medical facility servers) 102-106 may be remotely located and configured to transfer medical records via internet connection 114, Wide Area Network (WAN) or the like.

Each medical facility server 104-106 may store programs and maintain database 110-120 which contains data collected by the various computers in the medical facility. Various applications of the integrated healthcare information system may be resident in each of servers 104-106 in the medical facility and will be discussed in more detail below. The facility servers 104-106 generally comprise a combination of hardware such as a personal computer 122, a laptop computer 118, a Personal Digital Assistant (PDA) computer 120, medical image device 116 and the like, which are commutatively connected via a local area network (LAN). Additionally, a biometric device may be included for user authentication. Biometrics is an automated method of identifying a person or verifying the identity of a person based on a physiological or behavioral characteristic. Examples of physiological characteristics may include hand or finger images, facial characteristics, voice, and iris recognition. In a preferred embodiment of the present invention, a simple biometric device such as a personal universal serial bus (USB) fingerprint scanner or the like may be used, since the user authentication using biometric device provides high level of security for private medical history.

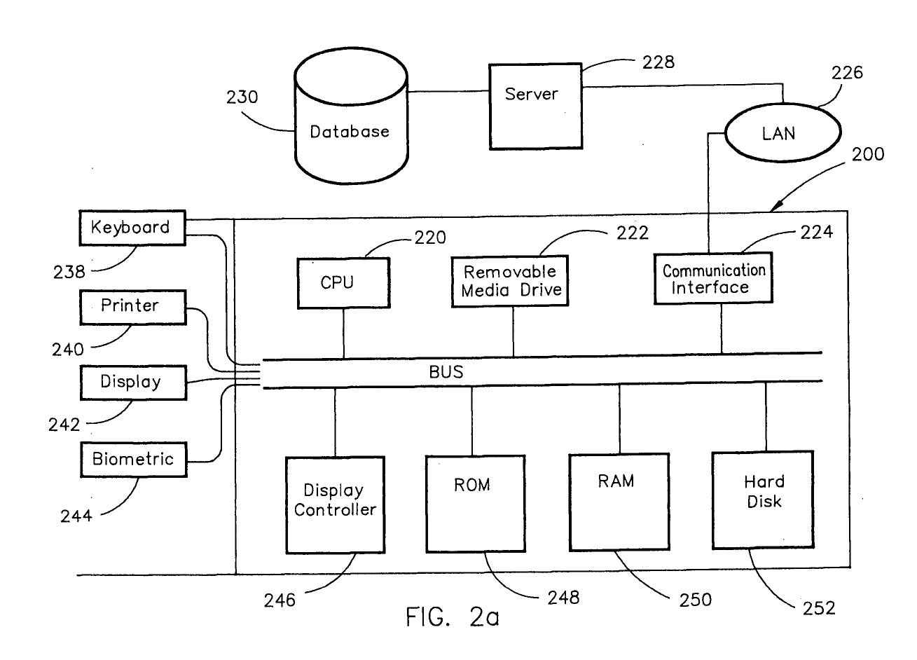

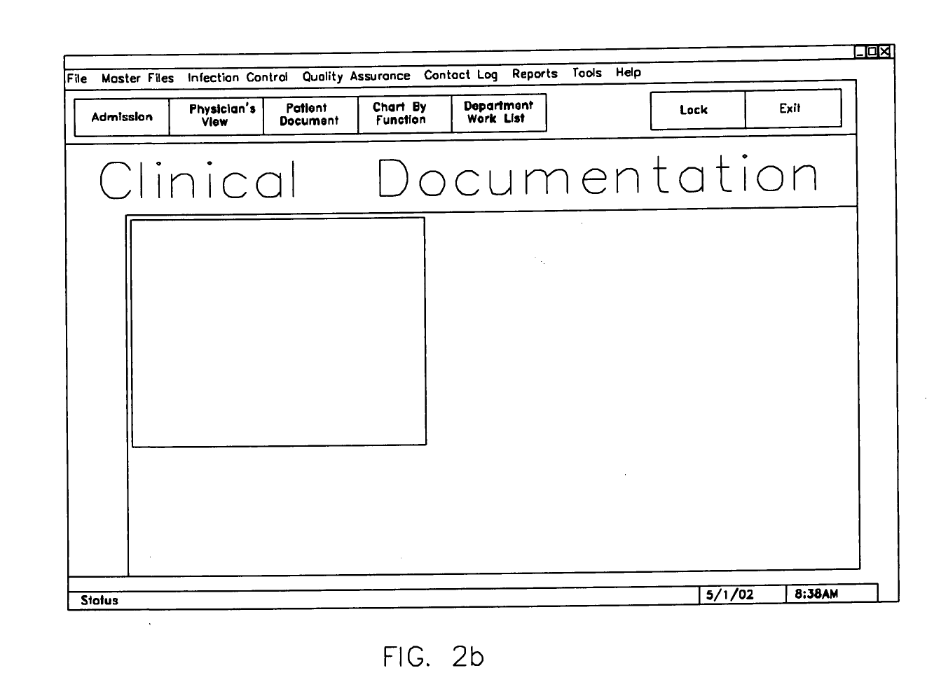

Referring now to FIG. 2a, a block diagram of computer system 200 in accordance with an exemplary embodiment of the present invention is shown. The computer system 200 may comprise a central processing unit (CPU) 220 coupled with the bus for processing the information, a removable media drive (such as CD ROM drive, DVD drive, Floppy diskette drive and the like) 222, a communication interface communicably connected to the Server 228 via LAN 226 and a random access memory (RAM) 250. One of the examples of RAM may be a dynamic RAM (DRAM), static RAM (SRAM), synchronous DRAM (SDRAM)) or the like. The computer system 200 further comprises a read only memory (ROM) 248 (e.g., programmable ROM (PROM), erasable PROM (EPROM), and electrically erasable PROM (EEPROM)), a hard disk drive 252, a display controller 246 coupled to the bus to control a display 242, such as a cathode ray tube (CRT), for displaying information to a computer user. The computer system 200 may also include input devices, such as a keyboard 238, a printer 240 and a biometric device 244 for a user authentication (using a finger print, an iris, a hand print or the like).

In an embodiment of the present invention, the integrated healthcare information system comprising a complete electronic medical record system may be divided into a patient registration, a financial management, a clinical documentation, an order management and the like. The integrated healthcare information system may allow users to view information provided by the above described applications such as a patient registration system (patient registration application), a financial management system (financial management application), a clinical documentation system (clinical documentation application), an order management system (order management application) and the like. Additionally, the user can view the list of predefined set of secured items which may correspond to menu items and fields in the actual applications.

The users in the present invention may be categorized into several classes suitable for the individual medical facility, for example, “nurse”, “physician”, “billing accountant”, “billing manager”, and the like. Each user class represents a set of security rules constructed using applications and their constituting items. Therefore, each user class may have different level of authority to access certain application or rights to read/write certain data in the database. Accordingly, the system may provide different views for user classes based on the level of authority.

In an embodiment of the present invention, a patient registration system (patient registration application) may maintain patient's record database in each local facilities and a global database (comprising an enterprise master people index, “EMPI”) in the designated server. All applications in the integrated healthcare information system may share the global database. When a patient visits a medical facility (a clinic, hospital, and the like), the patient record may be created regardless of the type of visit or admission. Thus, the patient may have a patient record (a medical record) that has been created per episode. Furthermore, EMPI supports multiple patient identifiers so that each medical facility can maintain its own medical record systems while sharing the global database. Insurance cards, photos and other documents may be scanned into the patient record. In an embodiment of the present invention, the user may be able to attach images to the user specified fields in a medical record. An example of the user specified fields may be “Advanced Directive field”, “Living Will field”, “Organ Donor field”, “Privacy Notice field” or the like. Once the user attached images to a medical record, the user may be able to view and access the images. For example, the system may support an image button to show a list of images attached to a patient and the user can access the image by clicking on the image button and double clicking on the image selected to view. The system may also support the user to attach images, including multiple page images, to the EMPI (global database).

Each patient can have a master medical record number for the global data base and additional medical record numbers per medical facility. For example, a unique enterprise-wide medical record number (master medical record number) may be assigned to a patient, which can be shared with local database servers of medical facilities and a facility unique medical record number may be assigned to the patient without consulting other facilities' database server. Therefore, the patient's medical record can be accessed by using different medical record numbers per medical facility while the master patient record may be accessed by using an enterprise wide medical record number. In this way, each medical facility has more flexible ways to maintain its own medical information but all medical records for a single patient may be linked together with a master medical record number.

In an advantageous aspect of the present invention, the system may maintain “people table” in which all people records (each record for patient, guarantor, employee, emergency contact, and the like) are all stored one time. The demographic information for the person (patient, guarantor, employee, emergency contact, and the like) and the employment information is kept in this table and accessed from all of the other tables that the person is associated with. When the person's information changes, it is only changed one time and carries throughout the entire system.

In another advantageous aspect of the present invention, a user may be able to predefine staff types which may be used to determine the scope of authority for the staffs (physicians, nurses, caregivers, pharmacists, administrators and the like) within the integrated healthcare information system. For example, a medication order can only be verified by a registered nurse (RN) or a pharmacist. A physician must sign physician orders, and the like. Each category of staff may have different authorities or requirements to access the system.

The user may also be allowed to define “patient classes” suitable for the need of an individual medical facility. One of the examples of using “patient classes” concept may be a Patient class table with associated flags. The patient class table may have many flags and defaults which the user can set to allow personalization for each type of patient. An example of flags may be a flag for registration defaults, forms, billings or the like. The system may also generate all revenue and patient census statistics by patent class. One of the examples of the people classes may include “Inpatient”, “Outpatient”, “Observation”, “Long-Term Care”, “Clinic”, “Swing Bed”, “Series Patient”, “Home Health” and the like.

Each patient class may have different admission forms that are printed at registration. Additionally, a forms library application may allow users to define and create their own forms easily by using predefined data sets such as “full admission”, “basic admission”, EMPI, medical records, and the like. This feature allows the user to create user specific reports easily. In an embodiment of the present invention, a graphic user interface (GUI) for registration which is unique based on the type of patient (which may be specified in the “patient classes”) may be supported. Co-pay information collected at time of admission is saved in a temporary table which will be merged into the account receivable deposit. The co-pays are deducted from the amount due on the patient bill and also are reflected in the account in the account receivable application. Additionally, any deficiencies and delinquencies are tracked through the system for chart components that are not completed on time.

Preferably, the system may provide a short cut for a user to move through master patient information and other major applications via a simple graphic user interface. For example, an “abstract screen” provides a view of the clinical components of a chart form where images related to patient information can be added via designated tab. The system may allow a user to submit electronic requests for a chart copy in order to receive a complete or partial chart copy electronically. The system will automatically bill the guarantor specified in the patient record and also send the bill to “account receivables”. “Work bucket” (reminder list) exists for each physician so they know what components they are missing and what transcriptions need to be signed. Additionally, the information on privacy authorizations, restrictions to an authorized user may be supported.

An order management system (order management application) may provide an automated management for all order related transaction including medical necessity, medicine, foods and the like. The order management system is a major component of the integrated healthcare information system of the present invention. Realistically, the order management system and patient care management system cannot be separately implemented since a patient cannot be treated without an order from a physician or a nurse. The user may select several order types and the corresponding screens will appear in the appropriate order so each order can be entered. In an advantageous aspect of the present invention, the patient's medical history (such as allergies and sensitivities) is also available from the order screen to prevent order errors.

The order management system may perform several very important checks on all orders: 1) Duplicate orders—Each order item will have a time period in which to check for duplicate orders. The system will alert the user at a predicted time and then allow them the option to continue the order. For example, if the time is set to 30 minutes and the same test is ordered within those 30 minutes, the system will alert the user for a test in every 30 minutes. 2) Medical Necessity—the system may perform checks on “Medicare outpatients” only to verify if a test is considered necessary based on the diagnosis of the patient. The system will have a “Medical Necessity” table which the user can create or which can be populated by a third party provider. If a test is being ordered which is not considered medically necessary, an ABN form must print for the patient to sign. This form authorizes the medical facility to do the test with the understanding the patient will pay the charges if necessary. 3) Conflict Checking—the system may check whether there is a conflict between a medication ordered for the patient and other medications, food, laboratory tests, and the like. Once the user enters a certain order to the order management system, the order may be sent to the selected department that will carry out the order. The selected department will be made aware of the order(s) by a printed order form produced on a designated printer, through a messaging system (e-mail, voice messages, a populated graphic user interface on the display device) or through both of printed forms and the messaging system.

Another major component of the integrated healthcare information system is a clinical documentation system which may allow physicians and staffs to access or record patient information without searching for a paper chart. In an embodiment of the present invention, the clinical documentation system may provide one form (a chart form) for a user to access all important information in the clinical documentation system with one click. The user may access information on “vital signs”, “assessments”, “care management”, “intake/output”, “flowsheets”, “medication administration record”, “test results”, “chart notes” and the like. In an alternative embodiment of the present invention, vitals and other periodic patient progress can be charted at the point of care on a wireless handheld terminal (e.g. PDA) so the patient record is always current.

FIG. 2b shows a main graphic user interface (GUI) of the clinical documentation information system. The clinical documentation information system may comprise “admission”, “patient document”, “chart by function”, “department work list” and “physician's view” options. When a user chooses “admission” option from the main GUI, the patient registration application may be launched in order to enter patient information to the global database and local databases. When the “patient document” option is chosen, another GUI may be displayed for a user to access or record a patient medical record. The “patient document” option will be discussed in more detail below. The “chart by function” option may allow the user to perform the same function on several patients quickly. For example, when a nurse makes rounds to check vital signs, she can come back to the workstation and pull up all of the patients in her unit and enter the vital signs from one place as opposed to opening up the chart form for each patient and then going to the vital signs tab and then clicking “new”. The “department work list” option may allow the user in a specific department to see all of the active orders for that department. For example, a radiology department may be allowed to see which patients are having what done and allows the user to administer an order once it is completed.

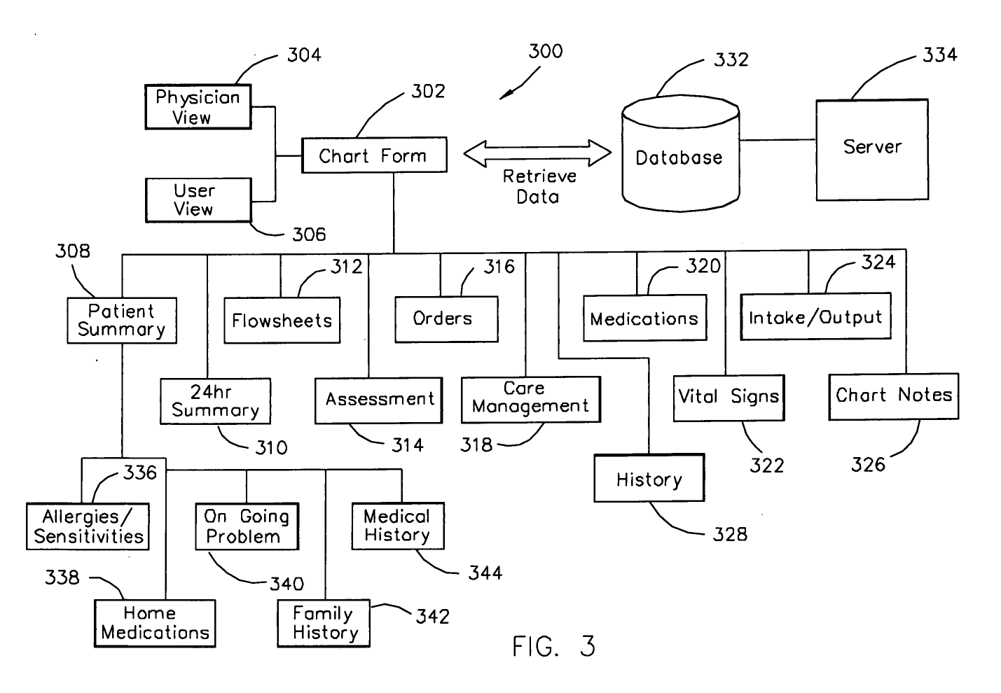

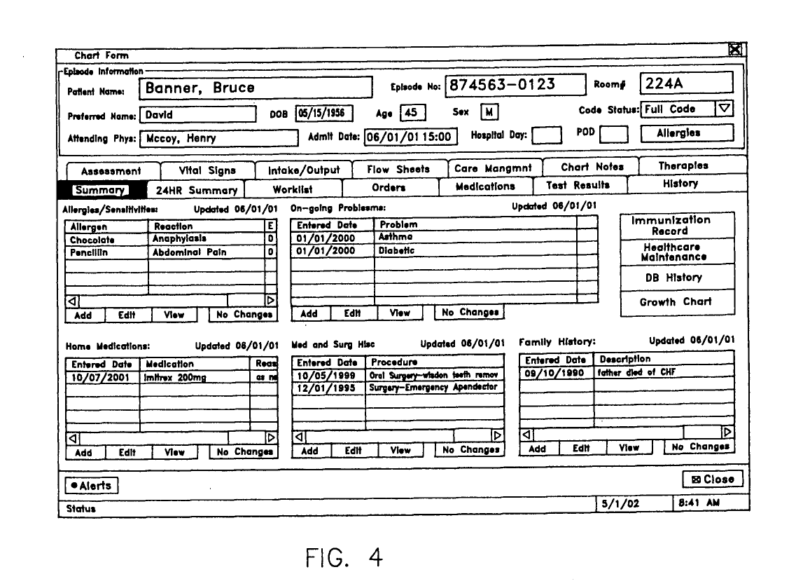

When the “patient document” option is chosen from the main GUI of the clinical documentation system, the patient document application may be launched. Referring now to FIGS. 3-4, a schematic diagram 300 illustrating relationships of various options in a patient document (a core of clinical documentation system) and an exemplary graphic user interface screen are shown.

The clinical documentation system may provide one form (a chart form) 302 for a user to access all important information in the clinical documentation system with one click. The chart form 302 may allow a user to access various options such as “vital signs” 322, “assessments” 314, “care management” 318, “Intake/Output” 324, “flowsheets” 312, “medications”(medication administration record) 320, “chart notes” 326, and the like with one click. The chart form 302 may also allow the user to view a “patient summary” 308, “24 hr summary” 310 and “history” (medical history) 328. The user may have graphed information for patient's vital signs, test results over time, and the like. In an advantageous aspect of the present invention, the chart form may be designed to allow the user to manipulate important applications in the integrated healthcare information system without leaving from the chart form screen. In other words, the user may not have to be aware of existence of different applications in order to maintain a patient documentation. This one click feature may provide an efficient way for documenting and charting. For example, the user can access the order management system (orders) 316 from the chart form 302 by clicking a designated tab.

The “assessment” 314 option may allow the user to determine the physical status of a patient. Conventionally, various types of assessments are completed on patients in any type of medical setting. Thus, assessments are one of the tools used by the medical world to determine the physical status of a patient. Another purpose of an assessment is to compare results to previous or baseline results to determine progress of a patient. There are many different types of assessments that may be used for a variety of reasons. The main purpose of patient assessments is to assist and help physicians to determine what to prescribe. Some of the assessments may be mandatory. In an embodiment of the present invention, the “assessment” option in the clinical documentation information system may provide for the maintenance of the patient assessments as well as the patient assessment process that includes the selection of a patient and the assessments to perform. Any type of physician, nursing staff or other discipline in a medical facility, may use the assessment option. The user may be able to evaluate the physical condition and progress or deterioration of the patient's health using “assessment” option. In an advantageous aspect of the present invention, the user may be able to quickly and efficiently record the results of any assessment in any health care environment. For example, the user may be able to chart on “glascow coma scale”, “aldrete score”, “anatomical diagram”, “home health oasis” and the like. All the assessments for any patient may be sorted by date and time. Thus, the “assessment” option may allow the medical facility to record patient data for internal evaluation and assessment and also to comply with regulatory standards.

The “intake and output” 324 option allows the user to maintain intake and output (I/O) items as well as the I/O entry process that includes the selection of a patient and the function to perform. “Intake and output” 324 may document and calculate a patient's intake and/or output. I/O is another integral component in the clinical assessment and treatment of a patient. Based upon a physician's order, or as a staff feels medically necessary I/O, will be obtained. Entering of I/O may range from every 5 minutes up to every 24 hours. Some examples of intake items are oral, I.V., internal feedings, blood and the like. Some examples of output items are urine, emesis, drainage from any type tube connected to a patient and the like. The intake and output” 324 option may also provide the history of an individual patient's Intake and Output over user-defined period of time, the different sites, locations and types of intake(s) and output(s) and detailed information on certain I/O item(s). The patient's intake and output data may be used to evaluate the fluid status, physical condition and progress or deterioration of the patient's health.

The system allows the user to define set of intake and output categories and items. Any static items in the I/O display will be determined and set by the user. “Intake and output” 324 may allow the user to quickly and efficiently record any type intake or output item. The system may provide an easy way to access all intake/output item(s) or amount(s) for any patient sorted by date and time or period of time, i.e. 8 hour shift. Thus, intake/output allows the medical facility to record patient data for internal evaluation and assessment and also to comply with regulatory standards. The frequency of I/O taken on a patient(s) is based upon a physician's order. I/O may be obtained routinely or after any type of surgery, procedure or treatment. In an alternative embodiment of the present invention, the user may be allowed to view recorded historical results to compare with current results and to determine trends. These results may also be graphed by clicking on the graph button. Images can be saved with results and viewed from within the results option. Multiple page images are also saved and can be viewed as one document.

“Chart notes” 326 may allow the user to view images (including multiple page documents) and transcribed documents. For example, chart notes, progress notes, chart checked notes may be implemented through the “chart note” 326 option. The user may select a patient whom they want to work on and then select the type of note (chart notes, progress notes, chart checked notes or the like). Physicians in the hospital setting may frequently use the progress notes to document daily assessments and progress of a patient during a hospital stay. Nurses or other staffs may choose to enter a chart note on a patient that is not available in other applications in the system. Furthermore, the system may identify the progress notes as a physician's or nurse's progress note based on the staff type of the user. The chart notes for the patent should be sorted with physician progress notes together and other progress notes together in descending order according to date and time with the most recent displayed first. Nurses and other disciplines progress notes should be stored together in the same manner described in physician progress notes. Transcriptions can also be reviewed by the user and returned to the transcriptions to be corrected.

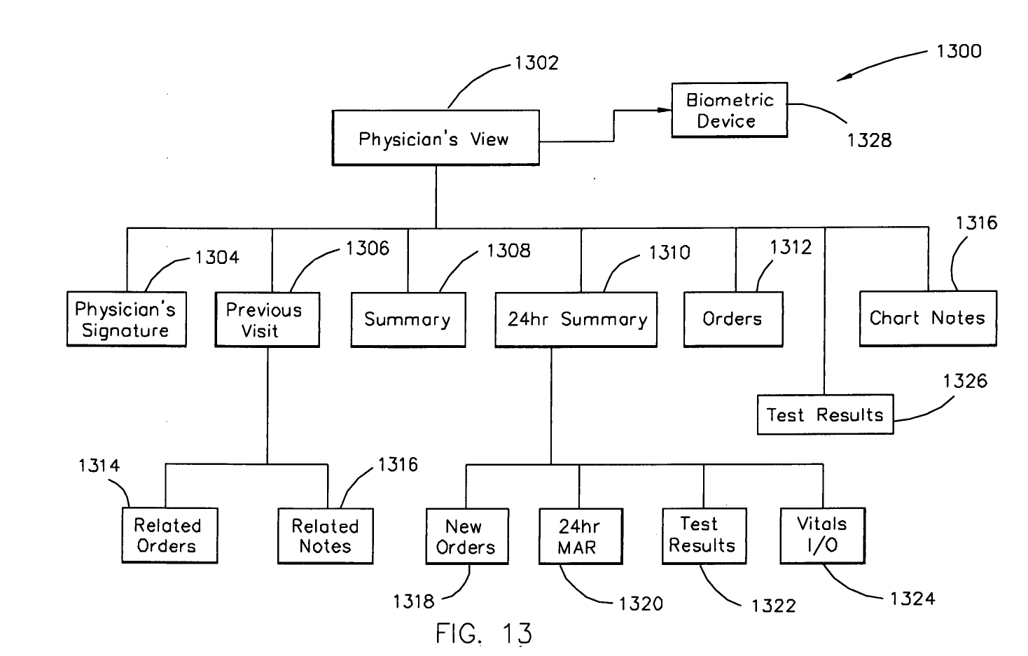

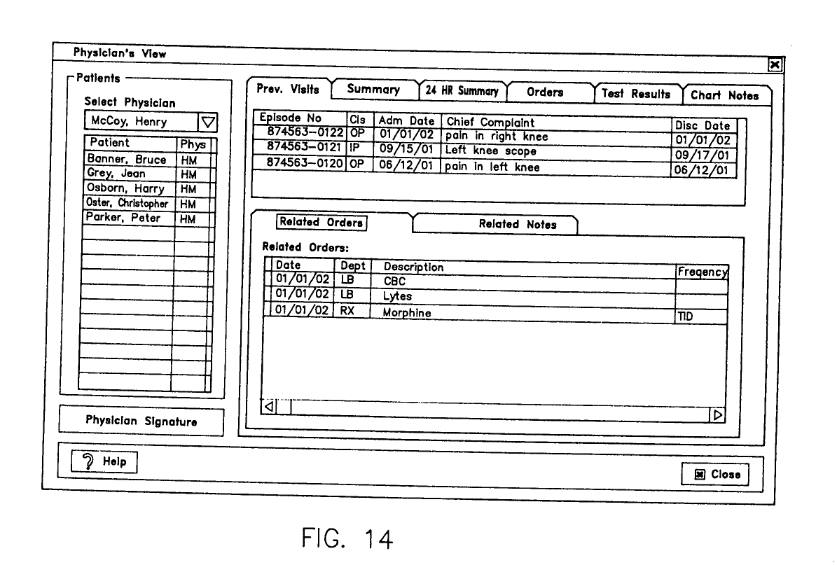

Generally, the information system may provide a default view for a user (user view 306) and a separate view suitable for a physician (physician view 304). A “physician view” 304 may contain some confidential information of the patient. Thus, each physician can access the view after successful user authentication using a biometric logon device. The “physician view” 304 will be further explained in FIGS. 13-14.

In an embodiment of the present invention, a patient summary screen may be a default GUI in the patient documentation system (clinical documentation system). FIG. 4 shows an exemplary GUI for “patient summary” option. The purpose of the “patient summary” option is to allow the user to look up a patient and readily obtain the medical history. The “patient summary” GUI will display the date when the information was last updated. Any user with rights assigned through security will have the ability to enter and update information. Through “patient summary” GUI, the user may enter, update or view “allergy information” 336, “family history” 342, “on going problem” 340, “medical history” 344, and “home medications” 338 for a patient. For example, allergy information 336 may include allergen and reaction for the patient and also alert the user about allergy information. Once allergy information is specified, the allergy button on all screens may turn red to denote the patient has an allergy or sensitivity. When there are no known allergies specified, the allergy button may remain black to denote “no known allergies.” “Family history” 342 may include information on the patient's family medical history with diagnosis codes, descriptions or the like. “On-going problem” 340 may include all unresolved diagnosis for the patient and date of onset. “Medical history” 344 may include procedure codes or descriptions of surgeries done on the patient. “Home medications” 338 may include all current medications and herbals the patient is taking. The “home medications” 338 can also generate a printed prescription for the patient. A history of refills and past medications may be recorded and viewed. In an embodiment of the present invention, the “patient summary” GUI may include several buttons such as “Home Medications”, “Immunizations”, “Growth Chart”, “Health Maintenance” and “Surgery Log”. “Growth chart” may track a child's height and weight and compares it to a national average. A chart to show growth information is also available. “Health Maintenance” may track tests that need to be repeated for the patient at given intervals. In an advantageous aspect of the present invention, the system can send out reminder notices to the patients when it is time for another appointment. “Immunizations” may track immunizations record for a person and compares them to the required immunizations so that the system can provides notice when another immunization is needed. “Surgery log” may track implants used in a surgery with the serial number.

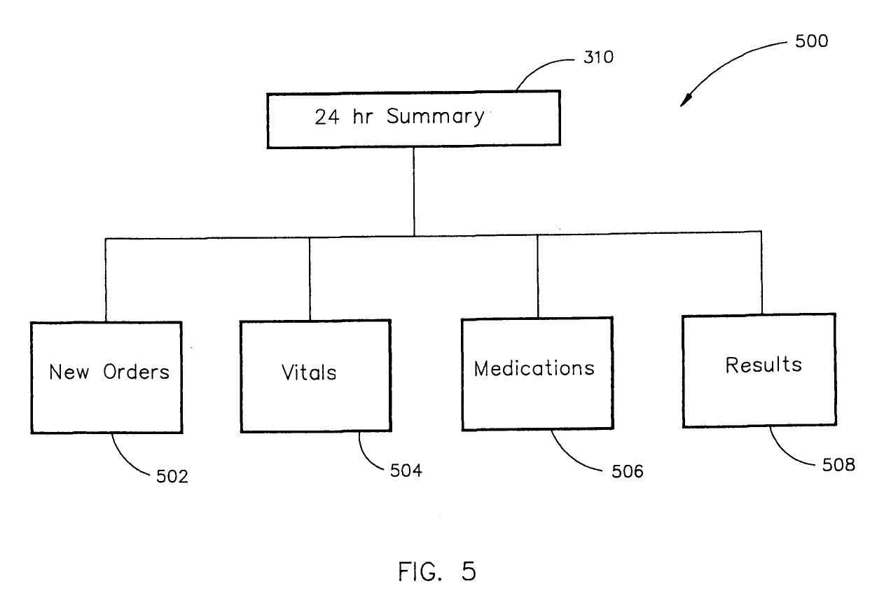

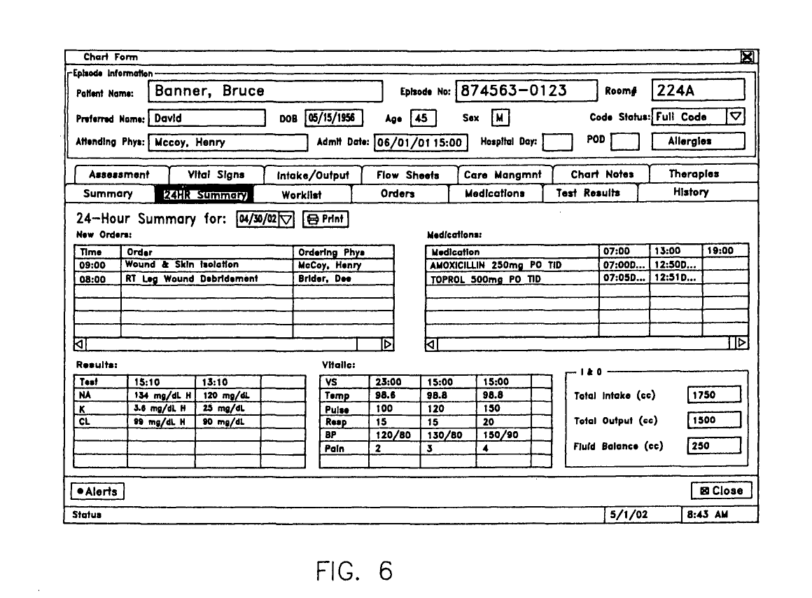

FIGS. 5-6 show a schematic diagram 500 illustrating relationships of various options in “24 hour summary” 310 and an exemplary graphic user interface screen for “24 hour summary”. The “24 Hour Summary” option 310 may provide a “quick review” of the patient for the previous 24 hours. This will be a view only screen and if the user wants more detail, they will go to the appropriate location in the chart. “24 hour summary” 310 may provide “new order” 502, “vitals” 504, “medications” 506, and “results” 508 options to the user. 24 hour summary screen is designed to provide the user with vital signs, intake and output with a fluid balance, orders placed, lab results obtained (“result”), medications administered and the like resulted during the last 24 hours (which is defined by the user).

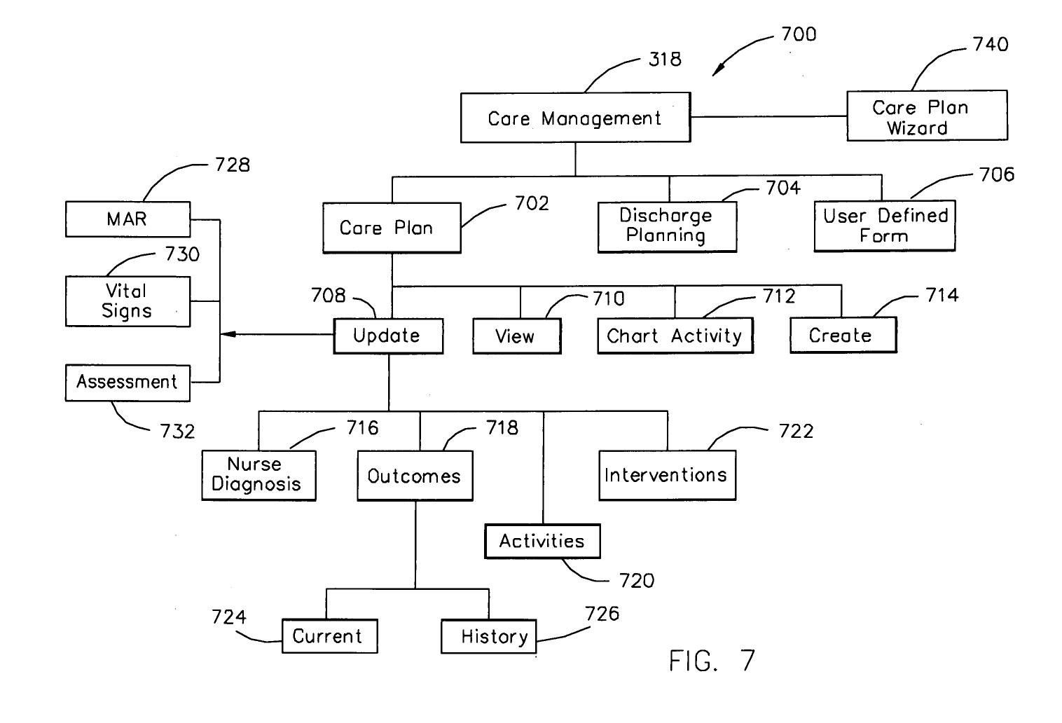

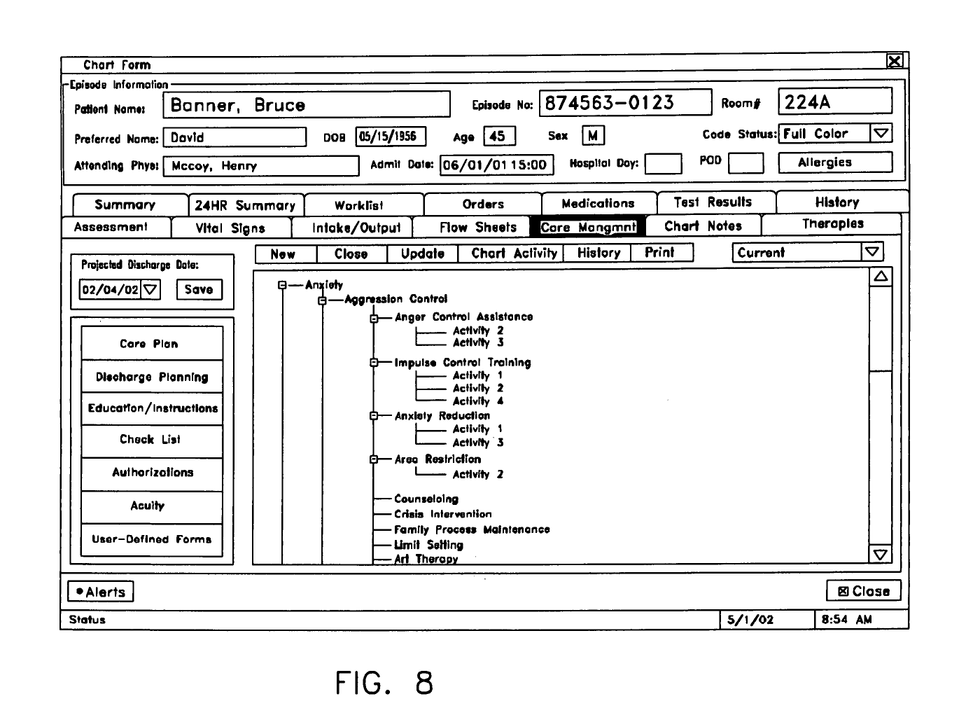

FIGS. 7-8 show a schematic diagram 700 illustrating relationships of options in a care management (care planning) 318 and an exemplary graphic user interface screen for care management are shown. “Care planning” 318 provides “care plan” 702, “discharge planning” 704, and “user defined form” 706 options to the user. When the user chooses the “care plan” option 702, the user can further manipulate the “care plain” option by choosing “update” 708, “view” 710, “chart activity” 712, and “create” 714 options. Additionally, the user may employ a “care plan wizard” application to create or update a care plan for the patient. Conventionally, in health industry, a care plan for the patient may be determined by the patient's admission diagnosis and becomes the basis for individualized patient care and charting documentation. NANDA (North America Nursing Documentation Association) has developed nursing diagnoses and care plans that are used as a standard across the country. The care plan management application may provide options incorporating NANDA standards. A nurse or other staff member may utilize the care management application to assist in the care of a patient. For example, “care plan” is initiated on the patient's day of admission and is another task to be completed during the admission process. By using the care management system in the present invention, a user may plan patient care to respond to each patient's unique needs (including age-specific needs), expectations, and characteristics with effective, efficient, and individualized care. In recent years, standardized interventions and outcomes have been developed based upon each nursing diagnosis incorporating standardized language and coding. NANDA (North America Nursing Documentation Association) has developed a set of Care Plans that are used as a standard across US. These are known as “knowledge based (KB) care plans”. Often these and the admission diagnosis are used as a starting point for preparing a patient's care plan.

In an embodiment of the present invention, the care management system may provide the above described standard developed by NANDA (such as standardized interventions, outcomes, KB care plans and the like) to assist nurses to plan a patient care. Accordingly, the “update” 708 option may include “nurse diagnosis” 716, “outcomes” 718, “activities” 720, “interventions” 722 and the like. “Outcomes” 718 may have two options such as “current” 724 and “history” 726.

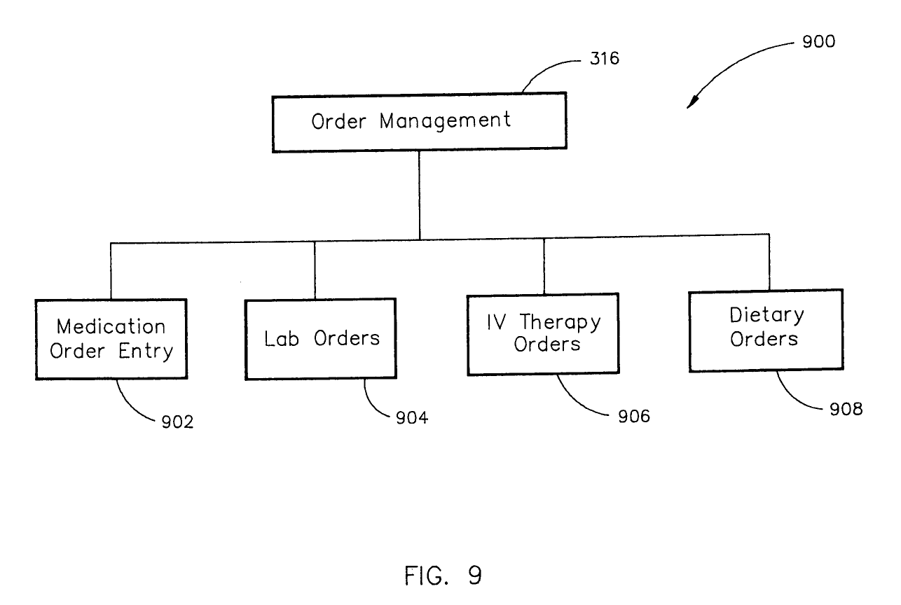

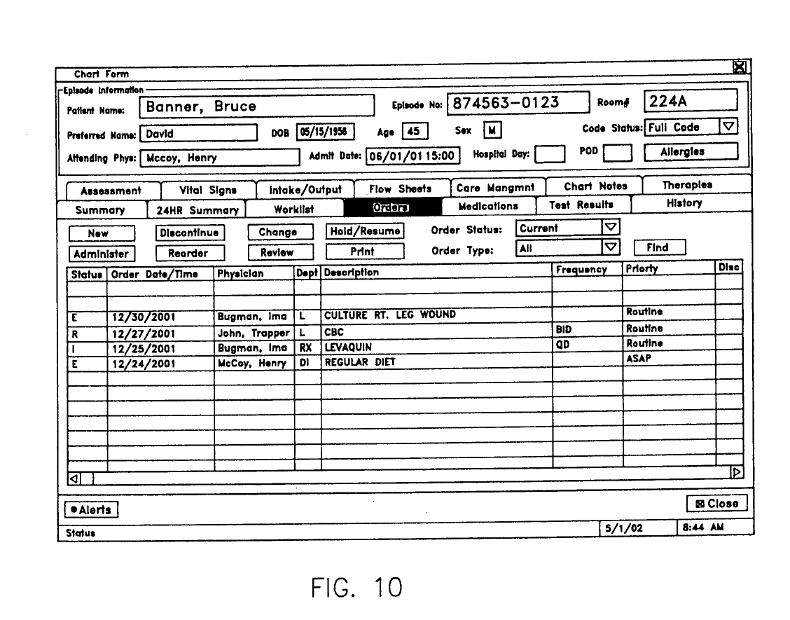

In FIGS. 9-10, a schematic diagram 900 illustrating relationships of options in order management (orders) 316 and an exemplary graphic user interface screen for order management are shown. The order management 316 may provide an automated management for all order related transactions regarding the patient treatment. Therefore, the user may define each order item to which special instructions, preparations, additional charges, tube type for laboratory test, frequency and dosage for medications, comments, alerts and the like can be attached. The user also defines the order departments they will use. The order management may include “medication order entry” 902, “lab order(s)” 904, “IV therapy order(s)” 906, “dietary order(s)” 908 options. For example, “medication order entry” 902 shows a list of top ten most ordered medications (top ten per department per unit) for ease of ordering. “Medication order entry” 902 may be used to prescribe medicine for the outpatient. When the user places any medication orders, the order will be verified by a pharmacist or by two registered nurses. Medication orders may be placed for a titrated medication, a sliding scale medication or the like. Diagnosis information may be shown, which flows from the patient registration system. “Lab order(s)” 904 may also show a list of top 10 most ordered laboratory orders. “Lab order(s)” 904 may include a test table that comprises specimen volume requirements tube specifications. The system may calculate the number and types of tubes required for the ordered items and print bar coded labels for each tube. The system may also check duplicated orders for the patient. “IV therapy order(s)” 906 may show unit specific top 10 IV orders in a check list for easy ordering. Referring now to FIG. 3, the information on Intravenous (IV) therapy order consolidates to “Intake and Output” 324 in the chart form 302. “Dietary order entry” 908 may also show a list of top 10 diet orders for easy ordering. The system may support more than one diet order per patient and patient diet preference and food allergy tracking.

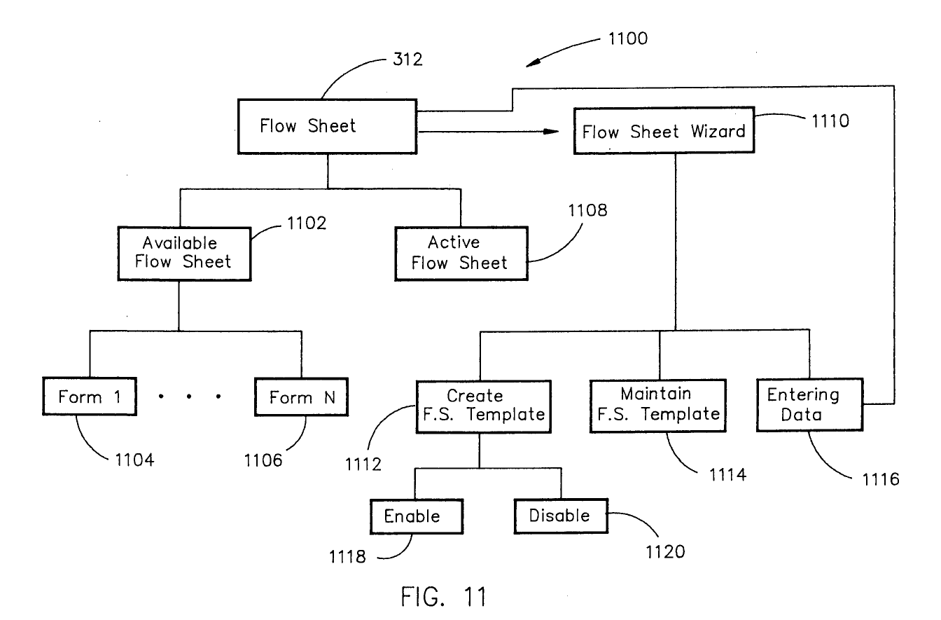

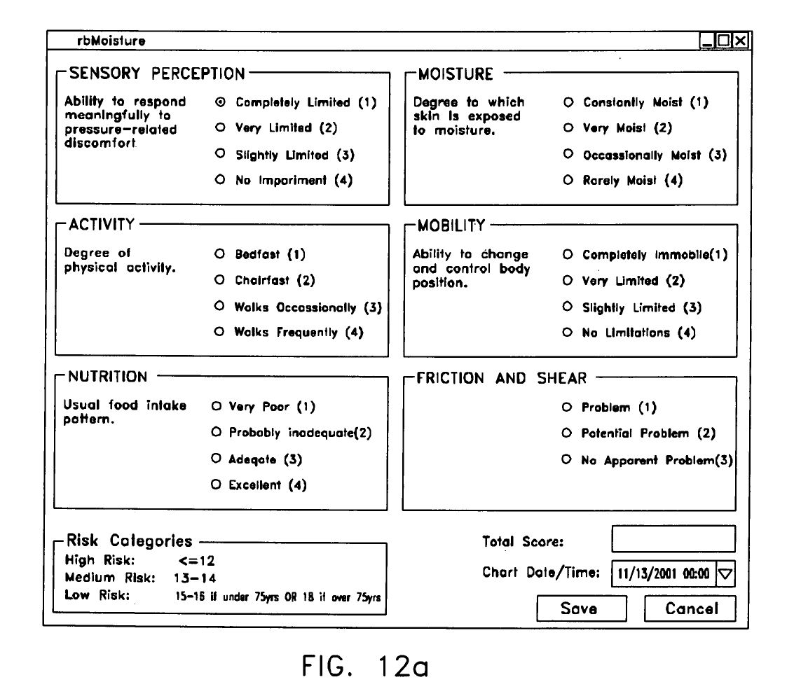

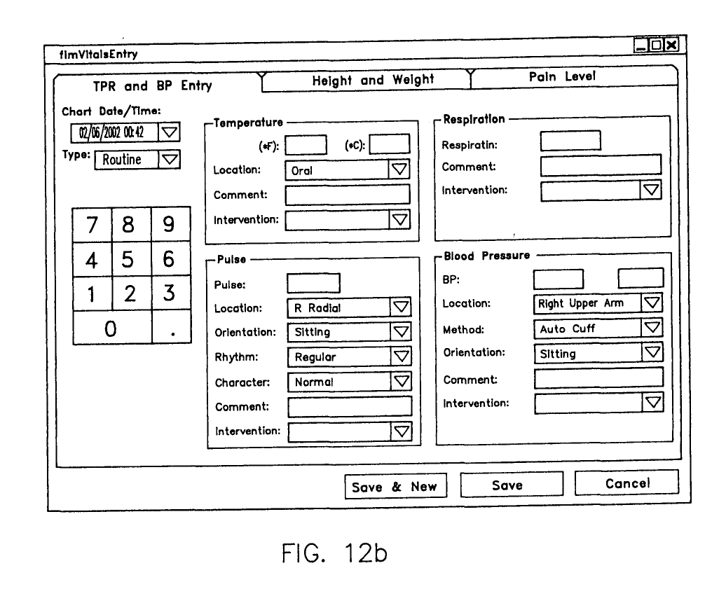

In FIGS. 11-12b, a schematic diagram 1100 illustrating relationships of various options in “flowsheets” 312 and exemplary graphic user interface screens of “flowsheets” 312 are shown. Referring now to FIG. 11, “flowsheets” may comprise “available flowsheets” 1102 and “active flowsheets” 1108 options. “Flowsheets” 1100 may display the list of available flowsheets (supported by the system or created by the user) and active flowsheets for the selected patient. The “available flowsheets” 1102 option may allow the user to choose previously created flowsheets forms 1104-1106. The user can either click on an available or an active flowsheet to enter the flowsheet data and press “entry”. The user may create a flowsheet form by using a “flowsheet wizard” application 1110. The “flowsheet wizard” may include “create flowsheet template” 1112, “maintain flowsheet template” 1114, and “entering data” 1116 options. Once the user create a flowsheet template using the “flowsheet wizard”, the flowsheets templates may be “enabled” 1118 to be used for data entry or “disabled” 1120 to prevent data entry.

FIGS. 12a-12b show exemplary graphic user interface screens of flowsheets provided by the system. In an embodiment of the present invention, several commonly used flowsheet forms (templates) are available for the user. An example of the system form may be “Brandon scale,” “current medication,” “immunization administration,” “vital signs-TRP and blood pressure entry” or the like. An exemplary screen for “Brandon scale” is shown in FIG. 12a. This flowsheet form may be used for data entry when the patient is admitted. An exemplary screen for “vital signs-TPR and blood pressure entry” is shown in FIG. 12b. This flowsheet may provide information on vital signs (Routine, Pre-Operation, Post-operation and the like) such as temperature (TPR), blood pressure, respiration, pulse of the patient. The user may be able to define normal ranges of vital signs. The vital signs may be graphed upon user's request. The user may attach comments or intervention made to any item along with this flowsheet.

In FIGS. 13-14, a schematic diagram 1300 illustrating relationships of options in “physician's view” 1302 and an exemplary graphic user interface screen for “physician's view” are shown. The “physician's view” 1302 may show an overview of the patient information of the current patients for a specified physician. The “physician's view” 1302 may be launched from the chart form 302. The physician's view 1302 may be only accessible by physicians. For the secured user authentication, a biometric device 1328 may be used for the user login. The system may show a physician view GUI based on the current user information assuming that the current user is a default physician. With the proper authorization, the user (physician) may also be able to sign orders for other physicians. For example, a list of the current patients for the selected physician may be displayed for easy access. If the user has an authority to order for all listed physicians, then this is a list of all of the current patients. Furthermore, the user may sign using the electronic “physician's signature” 1304. Preferably, the user may sign orders using the “physician signature button” that is designed to show the physician signature form in which the physician can sign orders and transcriptions. The “physician signature button” may also be designed to alert the user by a flashing red button when there are any unsigned items.

The physician's view may include “previous visit” 1306, “summary” 1308, “24 hour summary” 1310, “orders” 1312, “test result” 1326 and “chart notes” 1316 options. The “previous visit” 1306 option may show the previous episodes for the selected patient. The default order is descending admission date. The “previous visit” 1306 may include “related orders” 1314 and “related notes” 1316 options. The “related Orders” 1314 may show the orders for the selected previous visit. The “related orders” 1314 option may allow the user to see information on laboratory tests. The “related notes” 1316 option may show the notes for the selected previous visit.

The “summary” 1308 option may show the on-going problems, home medication, medical & surgical history, and family history information for the selected patient. The information that the “summary” option provides is the same as the information provided by the “patient summary” 308 option of the chart form 302. The “24 hr summary” 1310 option may show “new order” 1318, “24 hour medication” (24 hr medication administration record) 1320, “test results” 1322, and “vitals & I/O” 1324 information for the selected patient. The information of “24 hr summary” option is also the same as the information provided in the “24-hour summary” of the chart form. The “orders” 1312 option may show the orders for the selected patient. The information that “orders” 1312 provides is the same as the information provided by “order” of the chart form 302. The “test results” 1326 option may show the test result information for the selected patient. The information that the “test result” 1326 provides is the same as the information provided by “test results” of the chart form 302. “Chart notes” 1316 may provide the same information as “chart notes” of the chart form 302 may provide.

A financial management system is also one of the important applications of the present invention. In an embodiment of the present intervention, the financial management system (financial tracking) may provide an automated management for all financial related transactions including “patient billing”, “insurance processing”, “account receivable”, “general ledger” and the like. In an advantageous aspect of the present invention, the financial management system integrated with other management systems may reduce lost charges in the medical facility. For example, charges created by the order management system can be processed automatically by the “patient billing” application. Journal entries are created by the “patient billing” application and eventually merged to the “general ledger”. The user may choose to have charge rates automatically increase as the cost of chargeable inventory items increases.

The “patient billing” application may allow “on-line lookup” for quick, easy access to charge codes, patient admissions, physicians and the like. The history of all charge rates is stored so that late charges reflect the correct rate. Online billing is available when the service billing used in clinics, physician practice and other outpatient centers is generated. The user may be allowed to set flags for personalization of the patient billing application. An example of flags may be a charge entry flag, bill processing flag, claim creation flag and the like. In an embodiment of the present invention, the application may determine which insurance claim type is used for each patient. The service type may be recorded based on the services each patient has received when the services are billed for charges. Charge exceptions may be set for each patient class, financial class and insurance or the like. The prices, UB-92 Revenue Code, department, type of claim form, procedure code, covered by procedure and contractual adjustments can be set differently for each exception. These exceptions are used to get the charges to the right claim form with the correct UB-92 Revenue Code and price. The user may set up parameters for billing each patient class and financial class.

The “insurance processing” application supports a plurality of electronic formats for easy insurance filing. The user may use flags to control the flow of the claim. For example, the “Billed flag” is the date the bill was posted, “Coded flag” is the date the episode was coded, “Printed flag” is the date the claim was printed and the “Transmitted flag” is the date the claim was transmitted. In an advantageous aspect of the present invention, the user may specify which claims to print or transmit by the trading partner and type of claim and what format to use for the claim (e.g. NSF, Print Image or ASNI-837). The “insurance processing” application may include third party logs setup which allows the user to set up a tracking log by patient class and payer. The user may define third party logs for any financial class or insurance company. The revenue, expected payment, actual payment and adjustments are tracked. The number of days between discharge and billed, billed and coded, coded and transmitted and transmitted and paid are also tracked. Log reports are generated from this information.

The “accounts receivable” application may allow the user to view the balance of each bill, detail transactions, detail charges, notes and payment plans for each guarantor. In an embodiment of the present invention, transactions may be tracked by action code including internal action codes for charges posted, bills posted; financial class changed; statements sent, refunds and transfers. A daily balance report may be produced to compare the account receivable general ledger balance with the outstanding bills and outstanding charges and provides the difference if the two are not equal. The system may support transaction entry by guarantor, which allows payments and transactions to be entered for one guarantor at a time. The system may also support “transaction entry by action code” which allows transactions from one payer to be entered easily using the same action codes for the entries and “transaction entry by procedure code” which allows the transaction amount to be entered for each procedure provided. Additionally, “transaction entry for rural health clinic” feature may allow easy entry of transactions from the unique remittance advices issued to rural health clinics. The “overpayment action codes” feature may be used to record certain overpayments that are not reflected on the patient's account. The “Small Balance write-off” feature may compare the total amount to be written off for each guarantor and compares that balance to the maximum allowed to be written off per guarantor and prevents write-offs over that amount.

The “accounts payable” application may support a quick check option when the user wants to generate invoices. A check can be printed for an individual invoice instead of entering the invoice, saving it and then going to another option to print it.

The “general ledger” application may support “journal entry master table” that stores all journal entries in detail. Various reports on consolidated or detailed journal entries may be generated. For example, the consolidated journal entry may be generated by date, by batch or the like. The detailed journal entries may also be printed from the originating application in complete detail for any fiscal period/fiscal year. The user can change the consolidated flag at anytime to print the journal entries differently. When the journal entries are created from the applications, they are created in the “journal entry master table” but not posted. Financial statements can be generated in the “general ledger” application using these non-posted journal entries to obtain an up to the minute financial statement. The user enters the revenue and expense core accounts (four digit revenue centers and expense centers) into the core account table. They also enter the revenue and expense minor accounts (last three digits) into the minor account table. The “create chart of accounts” option matches the core accounts with the minor accounts to create the revenue and expense accounts for the chart of accounts. Revenue and expense centers can also be added to an existing chart of accounts using this tool. The system may also provide financial statements which are consolidated with detail and without detail statement options and consolidation within district statements. The system may also support a special reports creation tool using core accounts, minor accounts and exceptions to user defined statements. All reports may be available via a printer, a fax, an electronic file, a display monitor or the like.

In the exemplary embodiments, the methods disclosed may be implemented as a set of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the integrated healthcare information system of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A clinical documentation system, for use with a computing system, comprising:
a clinical documentation graphical user interface communicatively coupled with a database;
a chart form including an interactive display form communicatively coupled with the clinical documentation graphical user interface and the database; and
a clinical documentation option communicatively coupled with the chart form, the clinical documentation option for providing a plurality of interactive display forms for charting and tracking patient information,
wherein the clinical documentation option provides an integrated clinical information set of a patient for display on and manipulation by a user of the computing system employing the clinical documentation system.

2. The clinical documentation system of claim 1, wherein the clinical documentation option further comprises a summary option, a 24 hour summary option, and a flowsheet option.

3. The clinical documentation system of claim 1, wherein the clinical documentation option further comprises an order option, a care plan option, a results option.

4. The clinical documentation system of claim 1, wherein the clinical documentation option further comprises an infection control and tracking option.

5. The clinical documentation system of claim 1, wherein the chart form further comprises a wizard function communicatively coupled with the clinical documentation option.

6. The clinical documentation system of claim 1, wherein the database comprises a plurality of databases.

7. The clinical documentation system of claim 1, wherein the clinical documentation graphical user interface is remote from the database and portable.

8. The clinical documentation system of claim 1, further comprising an order management option.

9. The clinical documentation system of claim 1, further comprising a biometric validation sensor.

10. A financial tracker, comprising:
a general ledger communicatively coupled with a database, the general ledger for allowing journal entries for creating a financial statement; and
a chart of accounts option communicatively coupled with the general ledger, the chart of accounts for tracking of revenues and expenses from a core account and a minor account,
wherein the chart of accounts matches the core account with the minor account to provide the revenues and expenses for the financial tracker.

11. The financial tracker of claim 10, further comprising a core account table option for entry of revenue and expense of the core account.

12. The financial tracker of claim 10, further comprising a minor account table option for entry of revenue and expense of the minor account.

13. The financial tracker of claim 10, wherein the database comprises a plurality of databases.

14. The financial tracker of claim 10, further comprising a patient registration option.

15. The financial tracker of claim 10, further comprising a medical records option.

16. The financial tracker of claim 10, further comprising a billing option, an accounts payable option, and an accounts receivable option.

17. The financial tracker of claim 10, further comprising an insurance processing option.

18. The financial tracker of claim 10, further comprising a special reports option.

19. The financial tracker of claim 10, further comprising a biometric validation sensor.

20. An integrated healthcare network, comprising:
a clinical documentation system communicatively coupled to a database, the clinical documentation system for entry, manipulation, and display of clinical data; and
a financial tracker communicatively coupled to the clinical patient chart and the database, the financial tracker for entry, manipulation, and display of financial data,
wherein the clinical documentation system and financial tracker provide clinical documentation, order management, and financial management within the integrated healthcare network.

21. The integrated healthcare network of claim 20, further comprising a biometric validation sensor for controlling operation of the integrated healthcare network.

22. The integrated healthcare network of claim 20, wherein the database comprises a plurality of databases.

23. The integrated healthcare network of claim 20, further comprising a server for controlling the operation of the database.

24. The integrated healthcare network of claim 20, wherein the server comprises a plurality of servers.

25. The integrated healthcare network of claim 20, wherein the clinical documentation system and financial tracker are communicatively coupled with the server.

26. The integrated healthcare network of claim 20, wherein the clinical documentation system further comprises:
a clinical documentation graphical user interface communicatively coupled with a database;
a chart form including an interactive display form communicatively coupled with the clinical documentation graphical user interface and the database; and
a clinical documentation option communicatively coupled with the chart form, the clinical documentation option for providing a plurality of interactive display forms for charting and tracking patient information,
wherein the clinical documentation option provides an integrated clinical information set of a patient for display on and manipulation by a user of the computing system employing the clinical documentation system.

27. The integrated healthcare network of claim 20, wherein the financial tracker further comprises:
a general ledger communicatively coupled with a database, the general ledger for allowing journal entries for creating a financial statement; and
a chart of accounts option communicatively coupled with the general ledger, the chart of accounts for tracking of revenues and expenses from a core account and a minor account,
wherein the chart of accounts matches the core account with the minor account to provide the revenues and expenses for the financial tracker.

28. A clinical documentation electronic chart form communicatively coupled with a server communicatively coupled with a database, the clinical documentation electronic chart form for use by a healthcare provider in providing medical care to a patient, comprising:
a summary option for providing history information, medication information, allergy information, surgical information, and diagnosis information;
a 24 hour summary option communicatively coupled with the summary option, the 24 hour summary option for providing vital signs, intake/output, orders, lab results, and medication information covering a previous 24 hour period of time;
an order option communicatively coupled with the summary option, the order option providing for the entry of orders related to medical care;
a care plan option communicatively coupled with the summary option, the care plan option providing a multi-disciplinary care plan activity function;
a flowsheet option communicatively coupled with the summary option, the flowsheet option providing a form for data entry; and
a wizard option communicatively coupled with the summary option, 24 hour summary option, order option, care plan option, and flowsheet option, the wizard for customization of information provided by the clinical documentation electronic chart form.

29. The clinical documentation electronic chart form of claim 28, wherein the clinical documentation electronic chart form is provided on a clinical documentation graphical user interface.

30. The clinical documentation electronic chart form of claim 28, wherein the graphical user interface further comprises a biometric validation sensor communicatively coupled with the server.

31. The clinical documentation electronic chart form of claim 28, further comprising a plurality of servers communicatively coupled with one another and the database.

32. The clinical documentation electronic chart form of claim 28, further comprising a plurality of databases communicatively coupled with one another and the server.

33. The clinical documentation electronic chart form of claim 28, further comprising a results option.

34. A financial tracker communicatively coupled with a server communicatively coupled with a database, the financial tracker for use by a healthcare provider in providing medical care to a patient, comprising:
a patient registration for establishing a record number for the patient being treated by the healthcare provider;
a medical records option communicatively coupled with the patient registration, the medical records option for storing and accessing a medical image;
a general ledger communicatively coupled with the patient registration, the general ledger for journal entries, the general ledger including a core account option and a minor account option for entering revenues and expenses;
a billing option communicatively coupled with the general ledger, the billing option for creating billing statements including accounts payable and accounts receivable; and
an insurance option communicatively coupled with the general ledger, the insurance option for providing insurance processing.

35. The financial tracker of claim 34, further comprising a special reports option.

36. The financial tracker of claim 34, wherein the medical records option enables a coding interface with third party coding applications.

37. The financial tracker of claim 34, further comprising an interface for communicatively coupling with a clinical documentation electronic chart form.
